(19) United States
(12) Patent Application Publication
(10) Pub. No.: US 2025/0211698 A1
(43) Pub. Date: Jun. 26, 2025

(54) IMAGE PROCESSING METHOD FOR DIVIDING IMAGE ACQUIRED BY IMAGE READING APPARATUS

(71) Applicant: CANON DENSHI KABUSHIKI KAISHA, Chichibu-shi (JP)

(72) Inventor: TAIGA SHIBAHARA, Musashino-shi (JP)

(21) Appl. No.: 18/980,335

(22) Filed: Dec. 13, 2024

(30) Foreign Application Priority Data
Dec. 26, 2023 (JP) 2023-218722

(51) Int. Cl. H04N 1/387; H04N 1/00; H04N 1/393

(52) U.S. Cl. CPC H04N 1/3876; H04N 1/00005; H04N 1/00068; H04N 1/00074; H04N 1/393

(57) ABSTRACT

An image reading apparatus comprises an image sensor configured to read a conveyance medium, a memory configured to store image data acquired by the image sensor, and a processor configured to generate a plurality of sub-image data by dividing the image data acquired by the image sensor at a dividing position. The processor is further configured to correct the dividing position when a coordinate of the dividing position is located in a character area.

### CROSS-REFERENCE TO RELATED APPLICATION(S)

This application claims priority to and the benefit of Japanese Patent Application No. 2023-218722 filed on Dec. 26, 2023, the entire disclosure of which is incorporated herein by reference.

### BACKGROUND OF THE INVENTION

### Field of the Invention

The present invention relates to an image processing method for dividing an image acquired by an image reading apparatus.

### Description of the Related Art

An image reading apparatus having a long reading function capable of conveying a long-length document is known. The image reading apparatus is capable of dividing a read image of a long-length document into a plurality of images.

On the other hand, a long image generated by reading a long-length document may be divided at a position not intended by the user.

Therefore, a technique for solving the above-described problems has been proposed in Japanese Patent Laid-Open No. 2005-244616. Specifically, a communication device acquires a capability of a transmission destination, that is, a size of a recording paper and a resolution of image data, performs optimal scaling process according to the capability of the transmission destination, performs dividing position adjustment process on the image data subjected to the scaling process, and divides a long image into a plurality of images. The dividing position adjustment process is a process in which a user sets an indivisible area from a read image and adjusts the dividing position so that the division is not performed in the indivisible area. This prevents the long image from being divided into a plurality of images at positions not intended by the user.

In this way, when the long image is divided by a certain length, the division at a position not intended by the user may be executed. In order to avoid this, it is necessary for the user to set the indivisible area from a preview image displayed on a screen.

### SUMMARY OF THE INVENTION

The present disclosure provides an image reading apparatus comprising: an image sensor configured to read a conveyance medium; a memory configured to store image data acquired by the image sensor; and a processor configured to generate a plurality of sub-image data by dividing the image data acquired by the image sensor at a dividing position, wherein the processor is further configured to correct the dividing position when a coordinate of the dividing position is located in a character area.

### BRIEF DESCRIPTION OF THE DRAWINGS

FIG. 1 is a schematic diagram of an image reading apparatus.

FIG. 2 is a block diagram showing a hardware configuration of the image reading apparatus.

FIGS. 3A and 3B show a UI screen displayed on an operation unit of the image reading apparatus.

FIG. 4 is a flowchart showing image division process.

FIG. 5 is a flowchart showing a blank area calculation process.

FIG. 6 is a flowchart showing a dividing position correction information calculation process.

FIG. 7 shows a blank area table.

FIG. 8 shown a correcting table.

FIGS. 9A to 9C show implementation of a division correcting process of the image reading apparatus.

FIGS. 10A and 10B illustrate a process of adding a margin.

FIG. 11 illustrates an information processing apparatus.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### 1. Overview

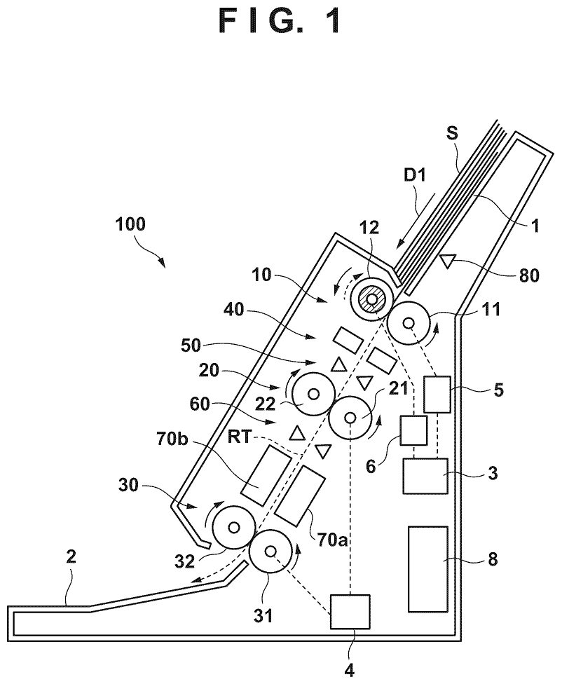

First, a basic configuration of the image reading apparatus 100 according to the present embodiment will be described with reference to FIG. 1. FIG. 1 is a diagram schematically showing an image reading apparatus 100 according to the present embodiment.

The image reading apparatus 100 is an apparatus that conveys one or more of medium S stacked on a placing table 1 one by one in a path RT, reads an image of it, and discharges the medium S to a discharge tray 2. The conveyance medium to be read is, for example, a sheet of an office automation (OA) paper, a check, a card, or the like. The sheet may be a thick sheet or a thin sheet. Examples of the cards include an insurance card, a license card, and a credit card. The cards include booklets such as passports. In the present embodiment, as an example, a long-length document such as a receipt is assumed as the conveyance medium S.

A first conveyance unit 10 is provided as a feeding mechanism that feeds the conveyance medium S along the path RT. The first conveyance unit 10 includes a feed roller 11 and a separation roller 12 disposed opposite to the feed roller 11, and sequentially conveys the conveyance medium S on the placing table 1 one by one in a conveyance direction D1.

The placing table 1 may be provided with a sheet sensor 80. The sheet sensor 80 detects the conveyance medium S stacked on the placing table 1. A drive unit 3 is a motor. The drive unit 3 rotates the feed roller 11 via a transmission unit 5. The drive unit 3 rotates the separation roller 12 via the transmission unit 6.

A multi-feed sensor 40 is provided downstream of the feed roller 11. The multi-feed sensor 40 detects multi-feed of conveyance mediums S. The multi-feed is a phenomenon in which a plurality of conveyance mediums S are fed from the placing table 1.

A medium sensor 50 is disposed between the first conveyance unit 10 and a second conveyance unit 20 and detects the conveyance medium S conveyed from the first conveyance unit 10 to the second conveyance unit 20.

The second conveyance unit 20 includes conveyance rollers 21 and 22. The conveyance rollers 21 and 22 convey the conveyance medium S while nipping it. The drive unit 4 is a motor. The drive unit 4 rotates the conveyance rollers 21 and 22 and discharge rollers 31 and 32.

The medium sensor 50 is disposed downstream of the second conveyance unit 20 and detects the conveyance medium S conveyed from the second conveyance unit 20 to image reading units 70a, 70b.

The image reading units 70a, 70b are image sensors disposed between the second conveyance unit 20 and a third conveyance unit 30. The image reading units 70a, 70b read an image from the conveyance medium S.

A controller 8 executes conveyance control and reading control of the image reading apparatus 100.

### 2. Hardware Configuration

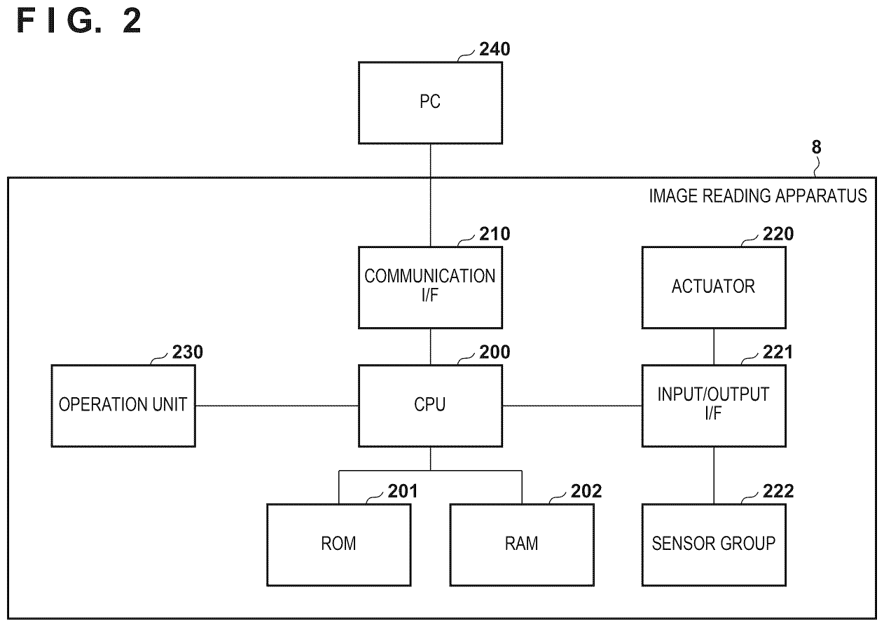

Next, an electrical hardware configuration of the image reading apparatus 100 according to the present embodiment will be described with reference to FIG. 2. FIG. 2 is a block diagram illustrating a hardware configuration of the image reading apparatus 100 according to the present embodiment.

A CPU 200 is a controller and a processor that comprehensively control each unit of the image reading apparatus 100. The term “CPU” is an abbreviation for “central processing unit”. A ROM 201 is a storage device that stores a control program executed by the CPU 200. ROM is an abbreviation for read-only memory. A RAM 202 is a storage device that stores various types of data that are used by the CPU 200 when the control program is executed. RAM is an abbreviation for random access memory.

The CPU 200 serves as an image dividing module for performing image division, a dividing position correction module for performing dividing position correction, a blank area calculation module for performing a calculation of a blank area, and a dividing position correcting amount calculation module for performing a calculation of a dividing position correcting amount, which will be described later.

The input/output I/F 221 is an interface (input circuit, output circuit) for communicating a control signal and a detection signal between the CPU 200 and an actuator 220. The input/output I/F 221 is also an interface for communicating control signals and detection signals between the CPU 200 and a sensor group 222. The actuator 220 includes the drive unit 3, the drive unit 4, the transmission unit 5, the transmission unit 6, and the like. The transmission unit 5 and the transmission unit 6 include, for example, an electromagnetic clutch that switches between transmission and disconnection of a driving force. The sensor group 222 includes the multi-feed sensor 40, the medium sensors 50 and 60, the image reading units 70a, 70b, and the sheet sensor 80. The operation unit 230 includes a switch, a touch panel sensor, a display, and the like.

The operation unit 230 displays information related to image reading, and receives an instruction and setting related to image reading from a user. The communication I/F 210 is an interface (communication circuit) for performing information communication with an external device.

The external device is, for example, a personal computer (PC) 240. The communication I/F 210 may be either wired communication I/F or radio communication I/F.

The PC 240 accepts an instruction related to image reading from the user, notifies the image reading apparatus 100 on it, and receives image data read by the image reading apparatus 100.

### 3. Image Reading Process

Next, a basic image reading process (scanning process) of the image reading apparatus 100 according to the present embodiment will be described.

Upon receiving an instruction to start reading from the operation unit 230 or the PC 240, the CPU 200 starts driving the first conveyance unit 10, the second conveyance unit 20, and the third conveyance unit 30. In some cases, a plurality of conveyance mediums S are stacked on the placing table 1. The conveyance mediums S are conveyed one by one from the lowermost conveyance medium S among the plurality of conveyance mediums S.

The CPU 200 determines presence or absence of multi-feed of the conveyance mediums S by using the multi-feed sensor 40. If it is determined that there is no multi-feed, the conveyance is continued. If it is determined that there is multi-feed, the CPU 200 stops the conveyance and ends the reading.

The CPU 200 starts image reading by the image reading units 70a, 70b of the conveyance medium S conveyed by the second conveyance unit 20 at a timing based on the detection result of the medium sensor 60. The CPU 200 generates image data based on an image signal transmitted from the image reading units 70a, 70b, and stores the generated image data in the RAM 202. The CPU 200 may transmit the image data to the PC 240. The read conveyance medium S is discharged to the discharge tray 2 by the third conveyance unit 30, and the image reading process of the conveyance medium S is completed.

### 4. Method of Starting the Image Reading Process from the Operation Unit 230

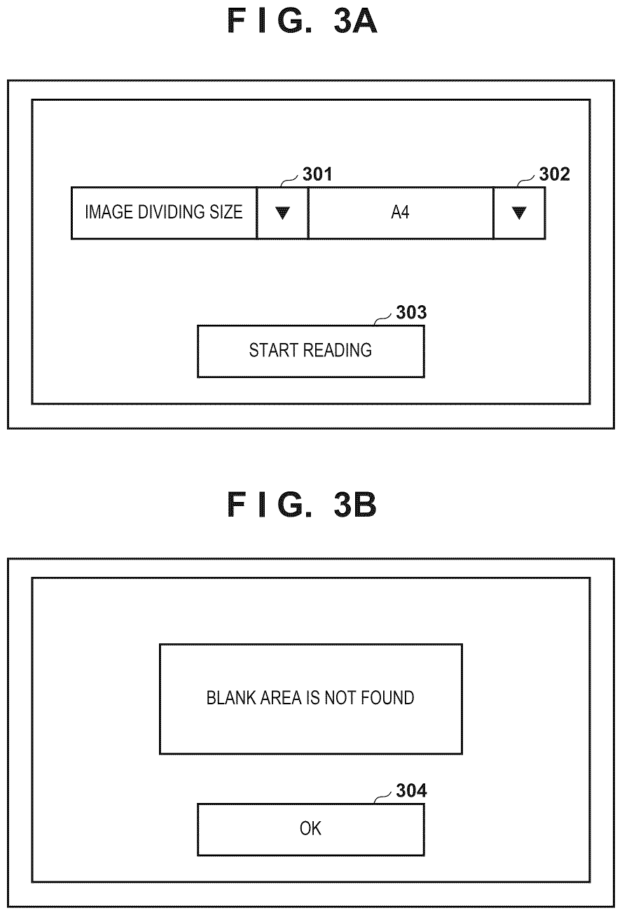

Next, an operation from the operation unit 230 provided in the image reading apparatus 100 will be exemplified with respect to a method of executing an image reading process in the image reading apparatus 100 with reference to FIGS. 3A and 3B. FIGS. 3A and 3B are exemplary screens displayed on the operation unit 230.

When a power of the image reading apparatus 100 is turned ON, the operation unit 230 displays the reading start screen shown in FIG. 3A. In the operation unit 230, when the image-dividing-size setting button 302 is pressed, the CPU 200 receives a setting of a dividing position. A designation unit of the image dividing position in the present embodiment is a document size, but this is merely an example. When an image-dividing-unit selection button 301 is pressed, the CPU 200 changes a specified unit to a unit capable of identifying a position, such as a length (number of lines, pixels, etc.) or coordinates. The user executes an arbitrary setting from a pull-down menu and presses a reading start button 303. When a CPU core detects that the reading start button 303 is pressed, it starts an image reading process.

### 5. Flowchart of Image Dividing Position Correction

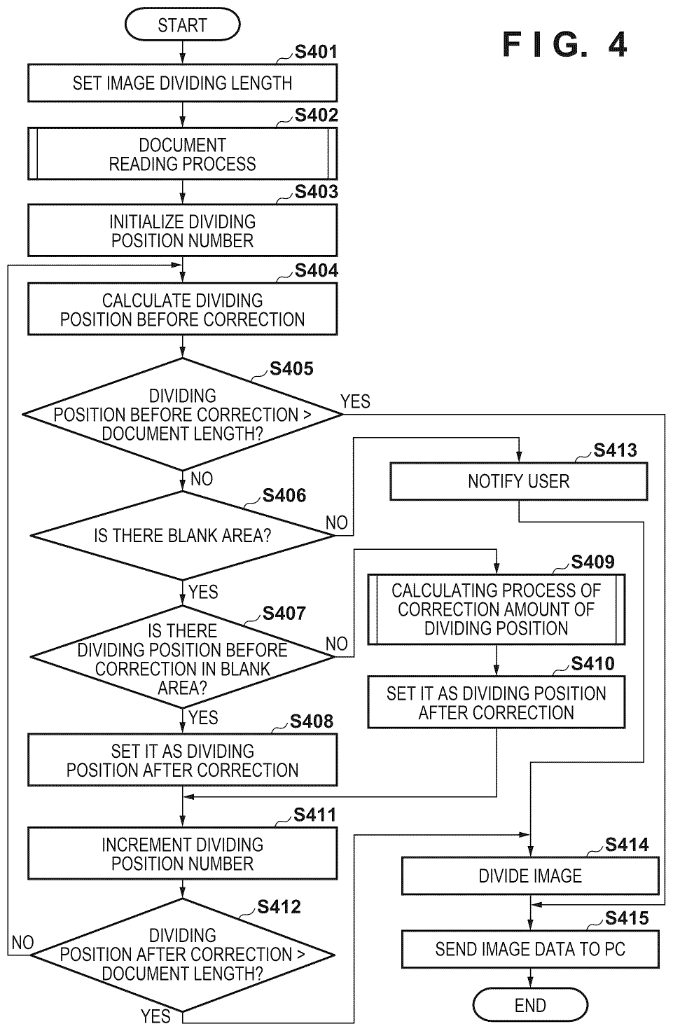

Next, dividing position correction in the present embodiment will be described with reference to FIGS. 4, 5, 6, 7, and 8. The dividing position correction is a process of correcting a position where a read image (which may be referred to as a document image or a main image) is divided into a plurality of sub-images. For example, a document image may include a character area. When the document image is divided in the character area, the visibility and the readability of a character may be deteriorated. Therefore, the image dividing position is corrected in order to avoid image division in the character area. As a result, the division is performed in a blank area of the document image.

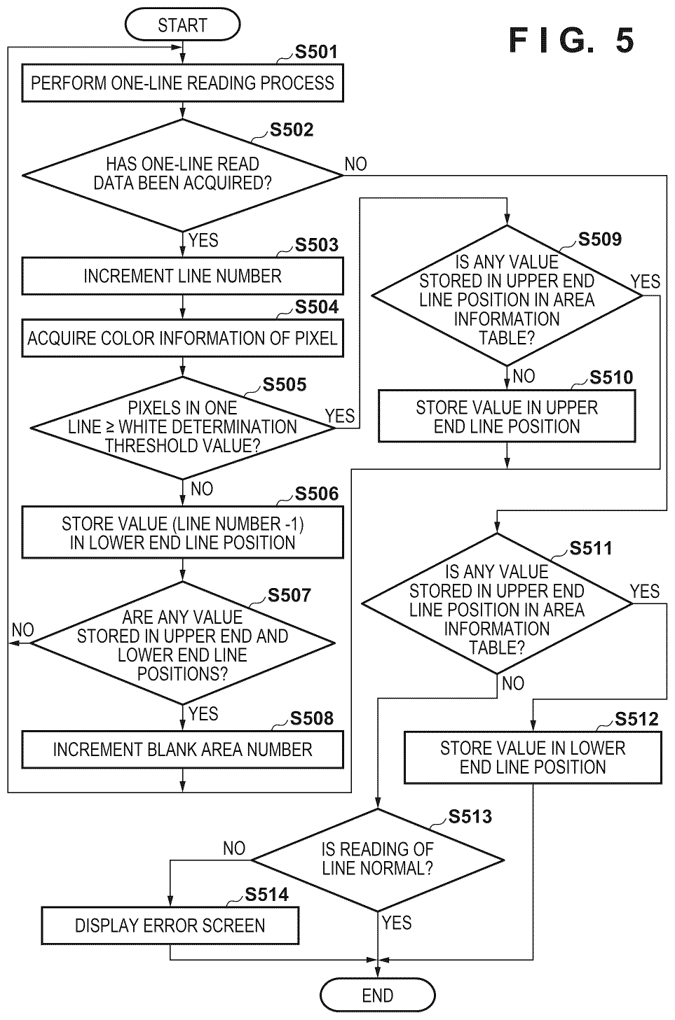

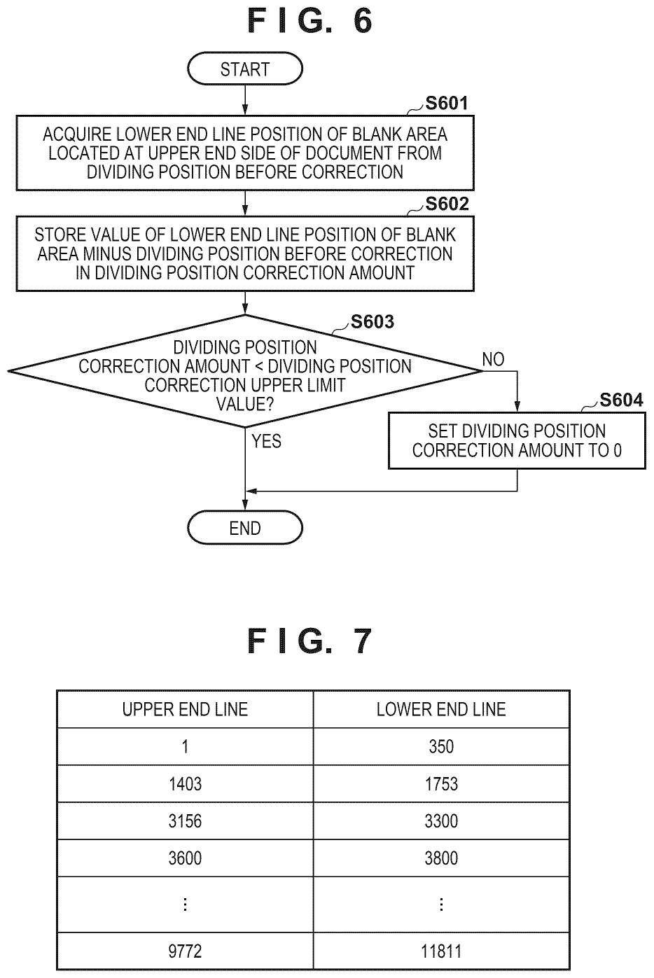

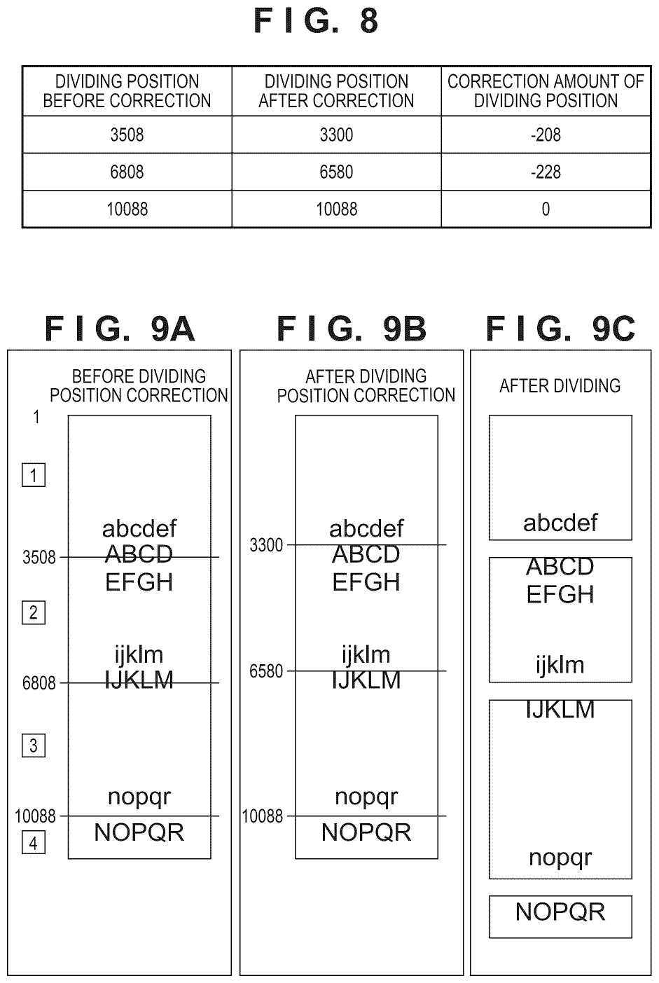

FIG. 4 is a flowchart showing an image dividing position correction of the image reading apparatus 100. FIG. 5 is a flowchart showing a calculation of a blank area. FIG. 6 is a flowchart showing a dividing position correction. FIG. 7 shows a table showing area information of a blank area. FIG. 8 shows a table showing dividing position correction information.

In the area information table shown in FIG. 7, the number of lines indicating a range of the blank area is calculated and stored. The area information table stores a top position and a bottom position indicating a value indicating how many lines the top and the bottom of the blank area are located from the top of the long-length document, respectively.

In the correcting table illustrated in FIG. 8, a value of the number of lines indicating the dividing position before correction, a value of the number of lines indicating the dividing position after correction, and a dividing position correcting amount are stored. The dividing position correcting amount is the number of lines indicating how much the dividing position is corrected. An initial value stored in a storage for storing a value of the dividing position before correction and an initial value stored in a storage for storing a value of the dividing position after correction are respectively “−1”. An initial value stored in the storage of the dividing position correcting amount is 0. This is to determine whether a value is stored in the table.

When the user presses the reading start button 303 displayed on the operation unit 230, the CPU 200 starts the following process.

In S401, the CPU 200 stores in the RAM 202 a length (size) set by the user for dividing the images.

In S402, the CPU 200 performs a long-length document reading process. In the present embodiment, the document size is set as the length for dividing the image. Therefore, the CPU 200 converts the document size into sub-scanning direction coordinates (the number of lines) of the dividing position by using the resolution. For example, when the set dividing size is A4 size (210 mm×297 mm) and the resolution of the images is 300 DPI, the number of lines indicating the sub-scanning direction coordinates of the dividing position is 3508 lines (=297/25.4×300). DPI is an abbreviation for dot part inches. When the reading process of the long-length document is completed, the CPU 200 proceeds from S402 to S403.

In S403, the CPU 200 initializes a dividing position number.

Here, the calculation of the blank area included the long-length document reading process in S402 will be described with reference to the flowchart of FIG. 5.

In S501, the CPU 200 performs one-line reading process on the document to be conveyed.

In S502, the CPU 200 checks whether or not one-line read data has been acquired.

If the read data has been acquired, the CPU 200 proceeds from S502 to S503. If the read data cannot be obtained, the CPU 200 proceeds from S502 to S511. When the document is conveyed in a skewed manner, the read image is skewed. In order to prevent this, the reading process may be executed while performing skew correction for each predetermined number of lines.

In S503, the CPU 200 increments the line number by one. The line number is a number indicating the position of the line on which the reading process is performed, and indicates the number of lines with the top of the image as the starting point of counting.

In S504, the CPU 200 acquires color information of pixels included in one read line.

In S505, the CPU 200 determines whether or not a character is included in the one read line by applying a white line determination method to the read images.

The white line determination method is, for example, as follows. The CPU 200 stores, in the RAM 202, a determination threshold for determining whether the pixel is white in advance. The CPU 200 determines whether all pixels in the one line are white. For example, CPU 200 uses a determination threshold value to determine whether or not all the pixels constituting one line acquired during the document reading are equal to or larger than the determination threshold value. If all the pixels included in the one line are white, the line is determined to be white. When all the pixels included in the one line are below the determination threshold value, it is determined that a character is included in the line.

As a consequence of the determination, if the line contains a character, the CPU 200 proceeds from S505 to S506. If it is a white line that does not contain any characters, the CPU 200 proceeds from S505 to S509.

In S505, the CPU 200 determines that the read one line is a white line, and thus determines whether or not a value is stored in the top line position of the area information table shown in FIG. 7. If it is stored, the CPU 200 returns from S509 to S501 and continues from S501. This means that the start position of the blank area is detected at least in the line that has already been read ahead, and the blank area continues.

On the other hand, when the value is not stored in the upper end line position (when the determination result of S509 was No), the CPU 200 proceeds from S509 to S510. In S510, the CPU 200 stores the present line number in the top line position of the area information table shown in FIG. 7. This means that a character has been detected up to the previous line, and it is same as the start position of the blank area has been detected. The CPU 200 then returns from S510 to S501 and continues the process.

In S506, the CPU 200 stores a value obtained by subtracting 1 from the present line number in the lower end line position of the area information table shown in FIG. 7.

In S507, the CPU 200 determines whether or not the top line position and the bottom line position of the area information table shown in FIG. 7 are stored.

If it is determined that the top line position and the line position are not stored, the CPU 200 returns from S507 to S501 and continues the process. This is to indicate that the character areas are continuously detected, and the CPU 200 performs the same detecting process on the next line.

On the other hand, if it is determined that the top line position and the bottom line position are respectively stored, the CPU 200 proceeds from S507 to S508.

In S508, the CPU 200 detects the end of the blank area, and therefore increments the number of blank areas in order to calculate the area information of the next blank area. That is, 1 is added to the number of blank areas. The CPU 200 then returns from S508 to S501 and continues the process. By incrementing the number of blank areas each time the range of the blank area is determined, the storage in the area information table shown in FIG. 7 is changed.

In some cases, it is determined that one-line read data cannot be acquired by S502. That is, there is a case where one line cannot be read. The CPU 200 then proceeds from S509 to S511. In S511, the CPU 200 recognizes that the reading has reached the end of the long-length document, and determines whether or not a value is stored in the top-line position of the area information table shown in FIG. 7. If a value is stored, the CPU 200 proceeds from S511 to S512. In S512, the CPU 200 stores the line number in the bottom line position of the area information table shown in FIG. 7. Thereafter, the CPU 200 ends the process. On the other hand, the CPU 200 proceeds from S511 to S513 if no value is stored in the upper end line position.

In S513, the CPU 200 determines whether the reading of the line is normal. If the reading is normal, the CPU 200 ends the process as it is. In some cases, an error occurs during reading, and the line data cannot be acquired normally. The CPU 200 then proceeds from S513 to S514. In S514, the CPU 200 displays an error screen on the operation unit 230 and ends the series of processes.

In FIG. 7, according to the flowchart of FIG. 5, it is shown that the blank area has been detected from the first line to the 350th line which is the beginning of the image. For example, another blank area is detected from the 1403th line to the 1753th line. Another blank area has been detected at the 3156th line through the 3300th line.

In the above description, an example in which the error screen is displayed on the operation unit 230 is described, but this is merely an example. The CPU 200 may send an error screen to the PC 240 and the error screen may be displayed on the PC 240.

The description of the flowchart of FIG. 4 is returned again.

When the document reading process is completed by S402, the CPU 200 proceeds from S403. In S403, the CPU 200 initializes the dividing position number and stores the dividing position number in the RAM 202.

In S404, the CPU 200 calculates a dividing position before correction. Here, the dividing position number is a value indicating the number of dividing positions at which the dividing position to be corrected is located from the top of the document. That is, the dividing position number is identification information or an index for distinguishing a plurality of dividing positions. The dividing position before correction is a value indicating a dividing position before corrected. For the first dividing position, the dividing position number may be multiplied by the length set by S401 to obtain a product, and the dividing position correcting amount may be subtracted from the product to calculate the dividing position before correction.

For example, if the dividing size is an A4 size, the dividing size set in S401 is 3508 lines. Therefore, the first dividing position before correction is 3508 (=3508×1−0).

The second and subsequent dividing positions before correction are calculated by subtracting a later-described dividing position correcting amount from the previous dividing position before correction to obtain a difference, and adding the set length to the difference. That is, the second and subsequent dividing positions before correction are calculated by adding the set length to the dividing position after correction acquired by S409.

The above calculation method is merely an example. As a calculation method of the dividing position before correction and the dividing position after correction, other calculation methods may be applied.

The initial value of the dividing position correcting amount is 0 as described above, but the actual value of the dividing position correcting amount is calculated by S409.

When the dividing position before correction is calculated by S404, the CPU 200 proceeds from S404 to S405.

In S405, the CPU 200 compares the dividing position before correction with the document length of the read document, and determines whether or not the dividing position before correction is larger than the document length. When the dividing position before correction is larger than the document length, the CPU 200 advances the process from S405 to S415. In S415, the CPU 200 sends the completed image data to the PC 240 and terminates the series of processes. When the dividing position before correction is equal to or smaller than the document length, the CPU 200 proceeds from S405 to S406.

In S406, the CPU 200 determines whether or not there is a blank area based on the area information table illustrated in FIG. 7. If there is no blank area, the CPU 200 proceeds from S406 to S413. In S413, the CPU 200 notifies the user that a blank area has not been detected. For example, the CPU 200 notifies the user of blank area non-detection by displaying a blank area non-detection screen shown in the FIG. 3B on the operation unit 230. When the CPU 200 detects that an OK button 304 is pressed, it proceeds from S413 to S414. In S414, the CPU 200 divides the document image into a plurality of sub-images based on the correcting table shown in FIG. 8, and stores the plurality of sub-images in the RAM 202. Thereafter, in S415, the CPU 200 sends a plurality of sub-images (sub-image data) to the PC 240, and ends the series of processes. However, this is merely an example. It would be sufficient to be able to notify the user that a blank area could not be detected.

If there is a blank area, the CPU 200 proceeds from S406 to S407. In S407, the CPU 200 determines whether or not the dividing position before correction calculated by S404 is within the blank area. As the criterion for determining whether or not there is a blank area, a criterion for obtaining the top line position and the bottom line position from the area information table, and determining whether or not the top line position and the bottom line position are equal to the initial value may be used.

As described above, in S407, the top line position and the bottom line position of the blank area corresponding to the number of existing blank areas are acquired from the area information table shown in FIG. 7, and it is determined whether or not the dividing position is within the area of the top line position and the bottom line position. If it is determined that the dividing position is within the blank area, the CPU 200 proceeds from S407 to S408. In S408, the CPU 200 stores the dividing position as it is in the dividing position after correction in the correcting table shown in FIG. 8. The CPU 200 proceeds from S408 to S411. In S411, the CPU 200 increments the dividing position number by one to calculate the subsequent dividing position. On the other hand, when the dividing position is outside the blank area, the CPU 200 proceeds from S407 to S409. In S409, the CPU 200 performs a calculation of a correcting amount of a dividing position, which will be described later.

FIG. 6 is a flowchart illustrating calculation of the correcting amount of the dividing position. In S601, the CPU 200 acquires the dividing position before correction from the RAM 202, and acquires the bottom line position of the blank area located at the topside of the document from the dividing position before correction. For example, the dividing position before correction may be 3508th line, and the bottom line of the blank area may be 3300th line.

In S602, the CPU 200 obtains a difference by subtracting the value of the bottom line position of the blank area acquired by S601 from the dividing position before correction, and stores the difference in the dividing position correcting amount. The dividing position correcting amount is the number of lines used in correcting the dividing position as described above. In the present embodiment, the dividing position correcting amount is “208” obtained by subtracting “3508” which is the dividing position before correction from “3300” which is the lower end line as shown in the correcting table shown in FIG. 8.

By comparing the dividing position before correction with the bottom line of each blank area, it is possible to determine a blank area located on the topside of the document from the dividing position before correction.

In S603, the CPU 200 compares the dividing position correcting amount with a dividing position correction upper limit value, and determines whether or not the dividing position correcting amount is larger than the dividing position correction upper limit value. When the dividing position correcting amount is larger than the dividing position correction upper limit value, the CPU 200 proceeds from S603 to S604. In S604, the CPU 200 sets the dividing position correcting amount to 0, and ends the series of processes. Thus, the correction of the dividing position is skipped. The dividing position correction upper limit value is an upper limit value that the dividing position correcting amount can take. When the dividing position correcting amount exceeds the upper limit value, it is impossible to correct the dividing position. In this case, since the document image is divided at the dividing position before correction, 0 is stored (set) in the dividing position correcting amount. When the dividing position correcting amount is smaller than the dividing position correction upper limit value, the CPU 200 ends the series of processes.

The description of the flowchart of FIG. 4 is returned again.

When the calculation of the dividing position correcting amount indicated in S409 is completed, the CPU 200 proceeds from S409 to S410. In S410, the CPU 200 obtains a difference by subtracting the dividing position correcting amount from the dividing position before correction, sets the difference as the dividing position after correction, and stores the difference in the dividing position after correction of the correcting table shown in FIG. 8. The CPU 200 then proceeds from S410 to S411.

In S411, the CPU 200 increments the dividing position number to calculate the subsequent dividing position. The dividing position after correction is a value of the dividing position after corrected. After the dividing position number is incremented by S411, the CPU 200 proceeds to S412. In S412, the CPU 200 compares the dividing position after correction with the document length of the read document, and determines whether the dividing position after correction is larger than the document length. When the dividing position after correction is larger than the document length, the CPU 200 proceeds from S412 to S414. In S414, the CPU 200 performs an image division process based on the correcting table shown in FIG. 8, and stores a plurality of sub-image data in the RAM 202. In S415, the CPU 200 sends a plurality of sub-image data to the PC 240, and ends the series of processes. When the dividing position after correction is equal to or smaller than the document length, the CPU 200 returns from S412 to S404 and performs the dividing position correction.

FIGS. 9A to 9C are diagrams showing a flow of dividing position correction. FIG. 9A is a diagram showing the dividing position before correction. Three dividing positions before correction are illustrated in FIG. 9A. Thus, the document image is divided into four sub-images.

In the character area, there are a first dividing position before correction and a second dividing position before correction. The first dividing position before correction is 3508th line. The second dividing position before correction is 6808th line. In the blank area, there is a third dividing position before correction. The third dividing position before correction is 10088th line. Therefore, the dividing positions that need to be corrected are the first dividing position before correction and the second dividing position before correction.

FIG. 9B is a diagram illustrating a dividing position after correction. The first dividing position before correction present in the character area is corrected from 3508th line to 3300th line. The second dividing position before correction present in the character area is corrected from 6808th line to 6580th line.

FIG. 9C is a diagram illustrating four sub-images generated by dividing the document image. The four sub-images are generated by dividing the document image at three dividing positions after correction.

### 6. Combining Sub-Images

Image combining when a long image generated by reading a long-length document such as a receipt is divided into a plurality of sub-images will be described.

The CPU 200 arranges the plurality of sub-images generated from the long image along the sub-scanning direction in a document area having an A4 size. More than two or more sub-images may fit in an A4 area. The CPU 200 then combines two or more sub-images. The CPU 200 combines the plurality of sub-images using a predetermined combining method. For example, the CPU 200 rearranges image data of each pixel included in the plurality of sub-images stored in the memory space of the RAM 202. As a rearrangement order, for example, a line in which each sub-image is connected by one line is arranged as one line. The CPU 200 reads out the image data rearranged in the A4 areas from the RAM 202 and transmits the image data to the PC 240. When two or more sub-images are not fit in the A4 area, the CPU 200 transmits the sub-images to the PC 240 as they are.

An area in which the plurality of sub-images can be arranged along the sub-scanning direction may be an area other than the A4 area. In this area, the same setting as the dividing size selected in FIG. 3A may be used. The area may be set in advance separately from the dividing size, or the area may be set by the user. In addition, a plurality of sub-images may be arranged in a main scanning direction instead of the sub-scanning direction.

According to the method described in the present embodiment, the division is prevented from being executed on the character area when the document image is divided. Furthermore, it is not necessary for the user to designate the indivisible area, and usability of the image reading apparatus 100 is improved. The CPU 200 can correct a dividing position to change a character area to an indivisible area.

In addition, a method in which an instruction to start reading is input from the operation unit 230 has been described as a method of performing reading by a user, but this is merely an example. For example, when a reading instruction is inputted from an externally connected information processing apparatus such as the PC 240, the same effect can be obtained.

In the present embodiment, a document to which the image division is applied is a long-length document, but this is merely an example. The image division described in the present embodiment may be applied to a document that is different from the long-length document. In this case, the same effect can be obtained.

In the present embodiment, in order to extract an area, the read image (document image) is analyzed by one line, and the coordinates of an area range are calculated. However, this is only an example. The CPU 200 may calculate the coordinates of the character area range using the area extracting module such as an OCR.

OCR is an abbreviation for optical character recognition.

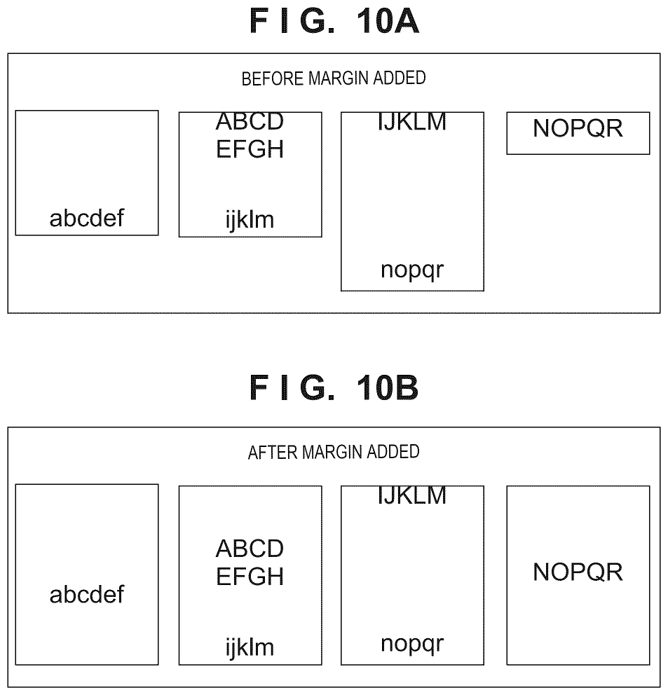

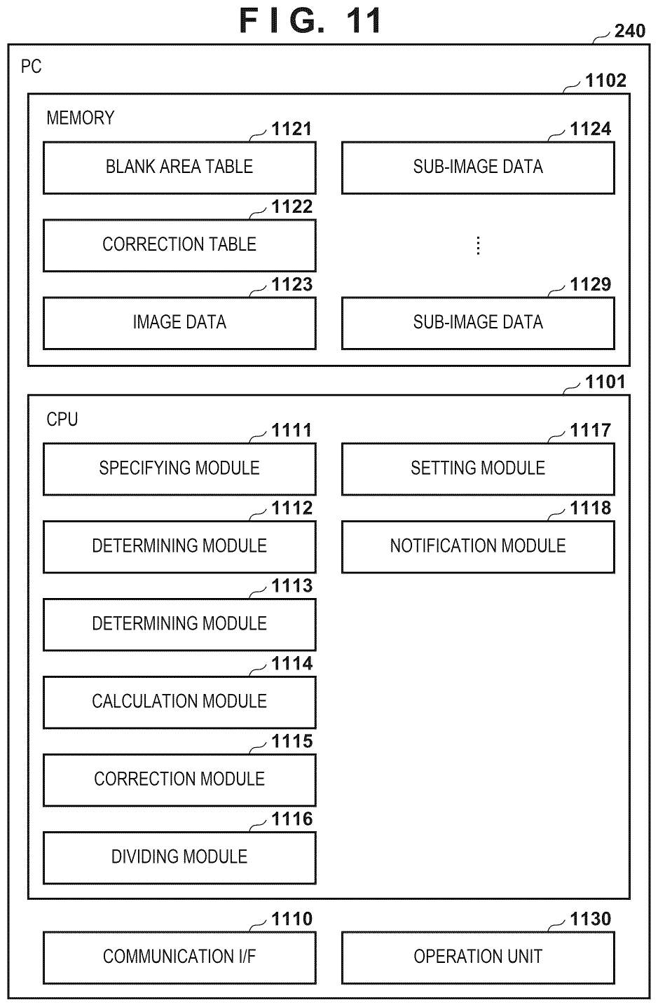

As shown in FIGS. 10A and 10B, in order to adjust the size of the sub-image, the CPU 200 may add a margin to the sub-image. FIG. 10A shows four sub-images generated by dividing a document image at a dividing position after correction. At this stage, no margins have been added to the four sub-images yet. FIG. 10B shows four sub-images with margins for size adjustment.

As illustrated in FIG. 10B, a position at which a margin is provided may be either the upper part, the lower part, or both the upper part and the lower part of the sub-image. Whether or not the sizes of the plurality of sub-images are adjusted to the same size (the same size adjustment), the size of the adjusted sub-images, and the position to which a margin is added may be set in advance or may be set or selected by the user through the operation unit 230. The margin addition is only one way to adjust the size of a sub-image. The present embodiment is applicable as long as the processing is capable of adjusting the sizes of a plurality of sub-images.

In the present embodiment, when a plurality of sub-images are not combined, the order of the sub-images may become unknown. Therefore, the CPU 200 may add an image indicating a page number on the respective sub-images. The presence or absence and location of the page number may be preset or may be set or selected by the user.

In the present embodiment, the image reading apparatus 100 executes the correcting processing of the dividing position and the division processing of the read image, but this is merely an example. These processes may be executed by the PC 240 connected to the image reading apparatus 100.

FIG. 11 illustrates the PC 240 functioning as an information processing apparatus in detail. The CPU1101 receives image data 1123 of a document image from the image reading apparatus 100 via a communication I/F1110, and stores it in the RAM area of a memory 1102. That is, the CPU 200 of the image reading apparatus 100 may only transmit the image data 1123 to the PC 240.

The memory 1102 is a storage device including the RAM area and a ROM area. The memory 1102 may include a hard disk drive and a solid state drive.

A blank area table 1121 is the table shown in FIG. 7. A correcting table 1122 is the table shown in FIG. 8. Sub-image data 1124 to 1129 are image data of sub-images generated by dividing the image data 1123 at a corresponding dividing position.

The CPU1101 realizes various functions by executing programs stored in the ROM areas of the memory 1102. A specifying module 1111 specifies a blank area and creates a blank area table 1121 by applying the process illustrated in FIG. 5 to the image data 1123. A determining module 1112 determines the dividing position before correction by executing the step S404. A determining module 1113 determines whether or not the dividing position before correction is larger than the document length. The determining module 1113 refers to the blank area table 1121 and determines whether there is a blank area. The determining module 1113 determines whether the dividing position before correction is within a blank area. The determining module 1113 determines whether the dividing position after correction is larger than the document length.

A calculation module 1114 executes the process illustrated in FIG. 6 to calculate the correcting amount of the dividing position. A correction module 1115 executes the steps S408 and S410, creates the correcting table 1122 shown in FIG. 8, and stores it in the memory 1102. For example, the correction module 1115 corrects the dividing position before correction with the correcting amount calculated by the calculation module 1114, and acquires the dividing position after correction. A dividing module 1116 divides the image data 1123 based on the dividing position after correction, and creates a plurality of sub-image data 1124 to 1129. The number of the plurality of sub-image data 1124 to 1129 varies according to the division length set in the step S401 by a setting module 1117. The setting module 1117 receives various settings input by a user through a keyboard or a pointing device included in the operation 1130.

A notification module 1118 displays various types of notification information on a display included in the operation 1130. For example, the notification module 1118 performs the step S413.

The CPU1101 also performs page-numbering, arranging a plurality of sub-images within a predetermined area, combining the plurality of sub-images, adjusting the size of the plurality of sub-images, and the like, described as being performed by the CPU 200.

The invention is not limited to the foregoing embodiments, and various variations/changes are possible within the spirit of the invention.

What is claimed is:

1. An image reading apparatus comprising:
an image sensor configured to read a conveyance medium;
a memory configured to store image data acquired by the image sensor; and
a processor configured to generate a plurality of sub-image data by dividing the image data acquired by the image sensor at a dividing position,
wherein the processor is further configured to correct the dividing position when a coordinate of the dividing position is located in a character area.

2. The image reading apparatus according to claim 1, wherein
the processor is further configured to calculate a dividing position correcting amount, and corrects the dividing position based on the dividing position correcting amount.

3. The image reading apparatus according to claim 2, wherein
the processor is further configured to specify a blank area of the image data, and calculate the dividing position correcting amount based on a difference between a value of a dividing position before correction, which is a dividing position before corrected, and a value of a lower end line position of the blank area on an upper end side of the image data than the dividing position before correction.

4. The image reading apparatus according to claim 3, wherein
the processor is further configured to notify a user when the blank area does not exist in the image data.

5. The image reading apparatus according to claim 2, wherein
the processor is further configured to compare the dividing position correction upper limit value with the dividing position correcting amount, and skip the correction of the dividing position when the dividing position correcting amount is larger than the dividing position correction upper limit value.

6. The image reading apparatus according to claim 1, wherein
the processor is further configured to combine two or more sub-image data of the plurality of sub-image data when the two or more sub-image data can be arranged in a predetermined area.

7. The image reading apparatus according to claim 2, wherein
the processor is further configured to receive a setting by a user regarding the dividing position.

8. The image reading apparatus according to claim 1, wherein
the processor is further configured to add a margin to the plurality of sub-image data, and adjust a respective sizes of the plurality of sub-image data.

9. The image reading apparatus according to claim 1, wherein
the processor is further configured to add a page number to the plurality of sub-image data.

10. An information processing apparatus comprising:
a receiving circuit configured to receive image data from an image reading apparatus for reading a conveyance medium;
a memory configured to store the image data acquired by the image reading apparatus; and
a processor configured to generate a plurality of sub-image data by dividing the image data acquired by the image reading apparatus at a dividing position,
wherein the processor is further configured to correct the dividing position when a coordinate of the dividing position is located in a character area.

11. The information processing apparatus according to claim 10, wherein
the processor is further configured to calculate a dividing position correcting amount, and corrects the dividing position based on the dividing position correcting amount.

12. The information processing apparatus according to claim 11, wherein
the processor is further configured to specify a blank area of the image data, and calculate the dividing position correcting amount based on a difference between a value of a dividing position before correction, which is a dividing position before corrected, and a value of a lower end line position of the blank area on an upper end side of the image data than the dividing position before correction.

13. The information processing apparatus according to claim 12, wherein
the processor is further configured to notify a user when the blank area does not exist in the image data.

14. The information processing apparatus according to claim 11, wherein
the processor is further configured to compare the dividing position correction upper limit value with the dividing position correcting amount, and skip the correction of the dividing position when the dividing position correcting amount is larger than the dividing position correction upper limit value.

15. The information processing apparatus according to claim 10, wherein
the processor is further configured to combine two or more sub-image data of the plurality of sub-image data when the two or more sub-image data can be arranged in a predetermined area.

16. The information processing apparatus according to claim 11, wherein
the processor is further configured to receive a setting by a user regarding the dividing position.

17. The information processing apparatus according to claim 10, wherein
the processor is further configured to add a margin to the plurality of sub-image data, and adjust a respective sizes of the plurality of sub-image data.

18. The information processing apparatus according to claim 10, wherein
the processor is further configured to add a page number to the plurality of sub-image data.
